(19) United States
(12) Patent Application Publication
(10) Pub. No.: US 2018/0322155 A1
(43) Pub. Date: Nov. 8, 2018

(54) SEARCH SYSTEM FOR TEMPORALLY RELEVANT SOCIAL DATA

(71) Applicant: Microsoft Technology Licensing, LLC, Redmond, WA (US)

(72) Inventors: Omar Rogelio Alonso, Redwood City, CA (US); Serge-Eric Tremblay, Pullman, WA (US); Vasileios Kandylas, Sunnyvale, CA (US)

(73) Assignee: Microsoft Technology Licensing, LLC, Redmond, WA (US)

(21) Appl. No.: 15/588,217

(22) Filed: May 5, 2017

(51) Int. Cl. G06F 17/30; G06N 5/02; G06N 3/00

(52) U.S. Cl. CPC G06F 17/30345; G06F 17/30572; G06F 17/3053; G06N 3/006; G06F 17/30554; G06N 5/022; G06F 17/30958

(57) ABSTRACT

Surfacing relevant socially trending informational items in response to an exploratory query is provided. A temporally relevant social data search system includes an intelligent assistant, a knowledgebase generation system, and a temporal graph knowledgebase. The knowledgebase generation system builds the temporal graph knowledgebase from entities and relationships detected in social data mined from a plurality of social networking data sources. Responsive to receiving an exploratory query associated with one or more entities, the intelligent assistant queries the temporal graph knowledgebase for information items related to the one or more entities, selects a relevant information item to include in a response, and provides the response to the user.

### BACKGROUND

Intelligent assistants are increasingly being utilized in search systems for providing information to users in response to a query. As the amount of information grows and as various types of information become more available, users have come to expect search systems to support search behaviors beyond simple factoid lookups. For example, a user may wish to perform an exploratory search for trending information about a given topic or entity. Currently, search systems may not be able to understand the user's intent, and will deliver information that does not fulfill the need of the user. The user may then rephrase the request hoping for temporally relevant social information, or may give up. As can be appreciated, this can be inefficient and frustrating to the user.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Aspects are directed to a device, method, and computer readable storage device for providing relevant socially-trending informational items to users by enabling the surfacing of trending social informational items responsive to an exploratory query that is temporally relevant to the requesting user. For example, a search system for temporally relevant social data is provided for generating and updating a graph knowledgebase based on trending social data. According to an aspect, the term “trending social data” is utilized herein to describe information items mined from a social networking data source or other data source that are popular, viral, or otherwise currently trending based on shares, likes, re-posts, mentions, etc. An exploratory query for information is received and analyzed for understanding the user's request, and the graph knowledgebase is queried for trending social information related to the request. The related information is filtered, and an informational fragment is selected and surfaced to the user in a response. According to aspects, the temporally relevant social data search system is able to understand a user's intent for trending social information and provide the information to the user in a conversational manner, thus providing an improved user experience and improved user interaction efficiency.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 is a block diagram illustrating an example environment in which a temporally relevant social data search system can be implemented for surfacing relevant socially trending informational items;

FIG. 2 is a block diagram illustrating components of an intelligent assistant and a knowledgebase generation system;

FIG. 3 is an illustration of an example query and response session between the temporally relevant social data search system and a user;

FIG. 4 is an illustration of another example query and response session between the temporally relevant social data search system and a user;

FIG. 5 is a flowchart showing general stages involved in an example method for generating and updating a graph knowledgebase of inter-related entities extracted from social data;

FIG. 6 is a flowchart showing general stages involved in an example method of surfacing relevant socially trending informational items;

FIG. 7 is a block diagram illustrating physical components of a computing device with which examples may be practiced;

FIGS. 8A and 8B are block diagrams of a mobile computing device with which aspects may be practiced; and

FIG. 9 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

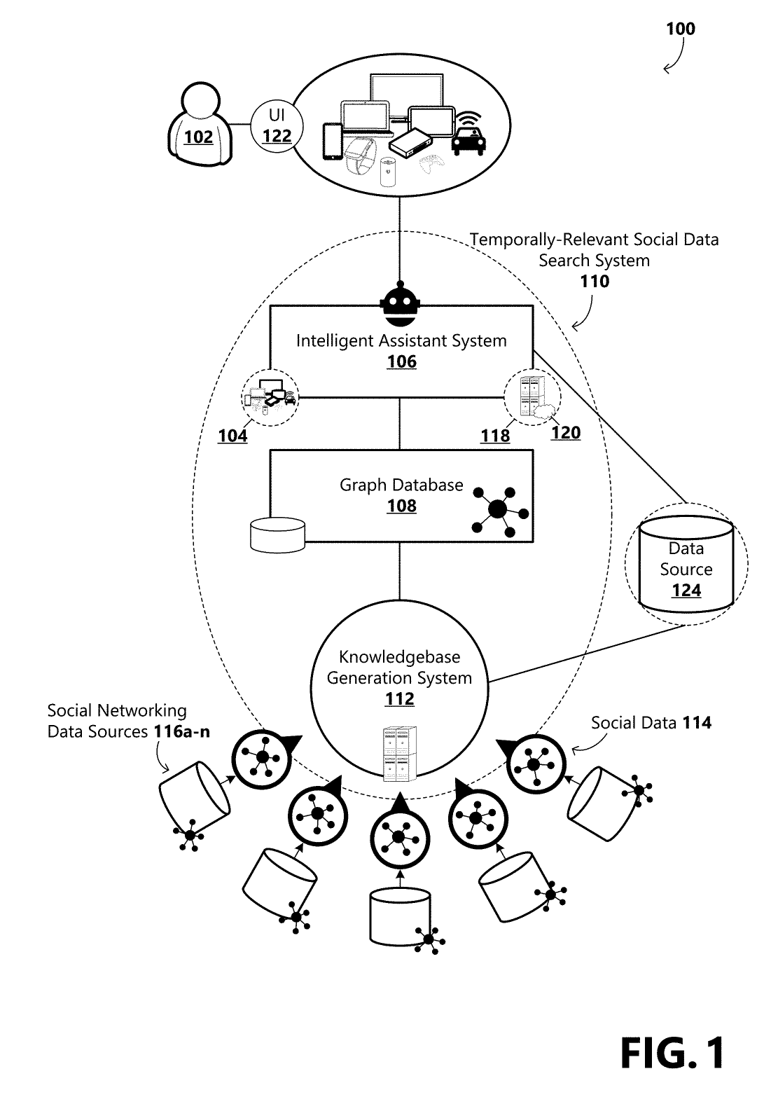

Aspects of the present disclosure are directed to a device, method, and computer-readable medium for surfacing relevant socially trending informational items in response to an exploratory query. FIG. 1 illustrates a block diagram of a representation of a computing environment 100 in which surfacing of temporally relevant social data responsive to an exploratory query may be implemented. As illustrated, the example environment 100 includes a temporally relevant social data search system 110, operative to surface relevant socially trending informational items responsive to an exploratory query. As utilized herein, the term “trending social data” describes information items mined from a social networking data source or other data source that are popular, viral, or otherwise currently trending based on shares, likes, re-posts, mentions, etc. According to an aspect, the temporally relevant social data search system 110 comprises an intelligent assistant 106, a knowledgebase generation system 112, and a graph knowledgebase 108. In some examples, the temporally relevant social data search system 110 comprises one or a plurality of computing devices 104 that are programmed to provide services in support of the operations of surfacing relevant socially trending informational items responsive to an exploratory query.

According to examples, a user 102 is enabled to utilize a computing device 104 to communicate with the intelligent assistant 106. For example, the computing device 104 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, or other type of computing device).

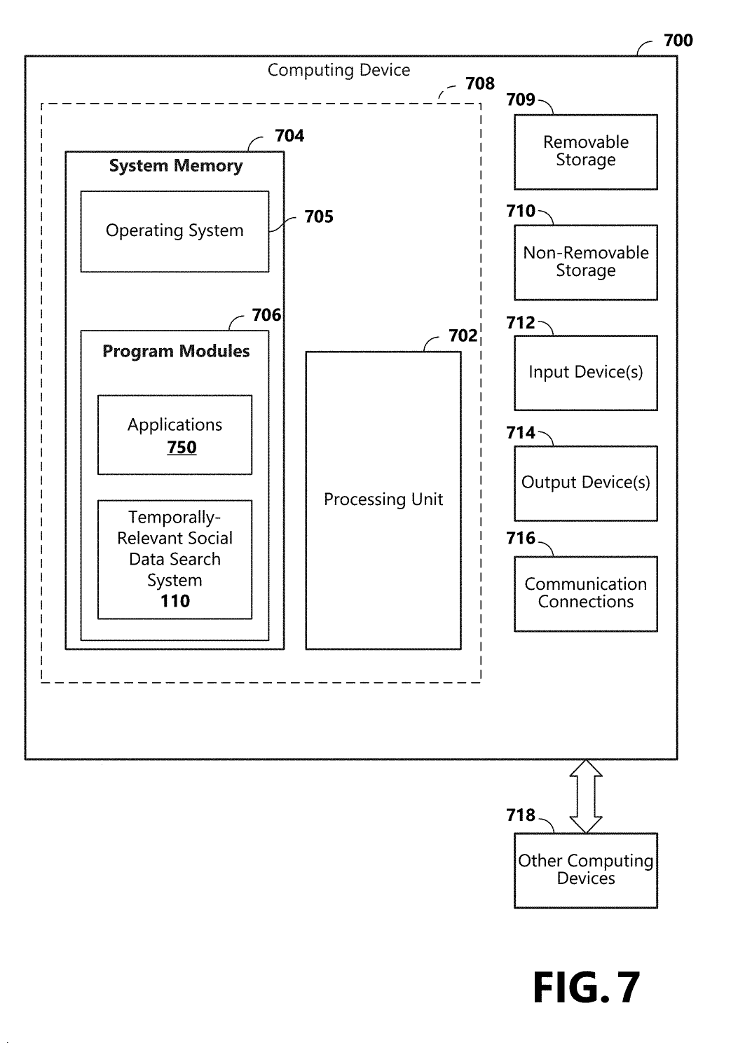

In some examples, the intelligent assistant 106 is executed locally on the computing device 104. In other examples, the intelligent assistant 106 is executed on a remote computing device or server computer 118 and communicatively attached to the computing device 104 through a network 120 or a combination of networks, which include, for example, and without limitation, a wide area network (e.g., the Internet), a local area network, a private network, a public network, a packet network, a circuit-switched network, a wired network, and/or a wireless network. According to an example, the user 102 accesses a remote intelligent assistant 106 via a user agent executing locally on the computing device 104. The hardware of these computing devices is discussed in greater detail in regard to FIGS. 7, 8A, 8B, and 9.

The user 102 is enabled to communicate with the intelligent assistant 106 via various types of communication channels, such as via email messaging, various text messaging services, digital personal assistant applications, social networking services, online video or voice conferencing, etc. Some communication channels employ a user interface (UI 122) associated with the intelligent assistant by which the user can submit a query and by which responses to the query, conversation dialog, or other information may be delivered to the user. For example, the user 102 is enabled to submit a query by asking questions, providing a topic. According to an aspect, the temporally relevant social data search system 110 is operative to receive an exploratory search query, and to provide temporally relevant social data to the user 102 responsive to the exploratory search query. For example, an exploratory query can include mentioning a particular entity (or entities) for seeking information about the entity (entities). One example exploratory query is “tell me about “X,” where “X” is a particular entity, such as a person, place, organization, movie title, book title, author of a social networking site post, current event, sports team, or other topic of interest. Another example exploratory query is simply “X.” Yet another example exploratory query is “tell me something about “X” and “Y,” where “Y” is another entity.

In some examples, the UI 122 is configured to receive user inputs in the form of audio messages and to deliver temporally relevant social data to the user 102 in the form of audio messages. In other examples, the UI 122 is configured to receive user inputs in the form of textual messages, and to deliver temporally relevant social data to the user 102 in the form of displayable messages. In one example, the UI 122 is implemented as a widget integrated with a software application, a mobile application, a website, or a web service to provide a computer-human interface for receiving user queries and for delivering temporally relevant social data that the search system 110 outputs to the user 102. According to an example, when input is received via an audio message, the input may comprise user speech that is captured by a microphone of the computing device 104. Other input methods are possible and are within the scope of the present disclosure. For example, the computing device 104 is operative to receive input from the user, such as text input, drawing input, inking input, selection input, etc., via various input methods, such as those relying on mice, keyboards, and remote controls, as well as Natural User Interface (NUI) methods, which enable a user to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence.

According to an aspect, the knowledgebase generation system 112 is illustrative of a software module, system, or device, operative to build a graph knowledgebase 108 based on social data 114, which is utilized by the intelligent assistant 106 for generating a response to a received query. In examples, the graph knowledgebase 108 is generated offline and continually updated with social data 114 mined from a plurality of social networking data sources 116a-n (collectively 116). For example, a social networking data source 116 is an online platform that allows users to interact with other users via a website or web service. As used herein, social networking data sources 116 include social media sites that have profiles and connections combined with tools to share online content of various types, such as posts, links, hashtags, photos, images, videos, and the like. In some examples, the knowledgebase generation system 112 is further operative to mine other data sources 124 for factoid or encyclopedic based information, and to include the factoid or encyclopedic based information in the graph knowledgebase 108 for surfacing information responsive to a factoid lookup-type query.

The graph knowledgebase 108 is illustrative of a repository of entities and relationships between entities. In the graph knowledgebase 108, entities (e.g., social networking posts, authors of social networking site posts, and people, places, organizations, movie titles, book titles, current events, sports teams, or other topics of interest that are mentioned in social networking posts) are represented as nodes, and attributes and relationships between the nodes are represented as edges connecting the nodes. Thus, the graph knowledgebase 108 provides a structured schematic of entities and their relationships to other entities. According to examples, edges between nodes can represent an inferred relationship or an explicit relationship. For example, connections between nodes can be direct or indirect. Accordingly, clever factoids represented by nodes in the graph knowledgebase 108 can be discovered based on obvious or non-obvious connections. According to an aspect, the graph knowledgebase 108 is continually updated with social data 114 mined from a plurality of social networking data sources 116, and is temporally annotated. For example, unless otherwise requested in a query, a latest snapshot of social data 114 that is mined and relationally stored in the graph knowledgebase 108 is searched for entities related to the query input. In one example, raw data is stored in the graph knowledgebase 108. In some examples, previous snapshots of social data 114 are maintained in the graph knowledgebase 108 for surfacing social data 114 from a previous point in time (e.g., last year, last month, last week, yesterday).

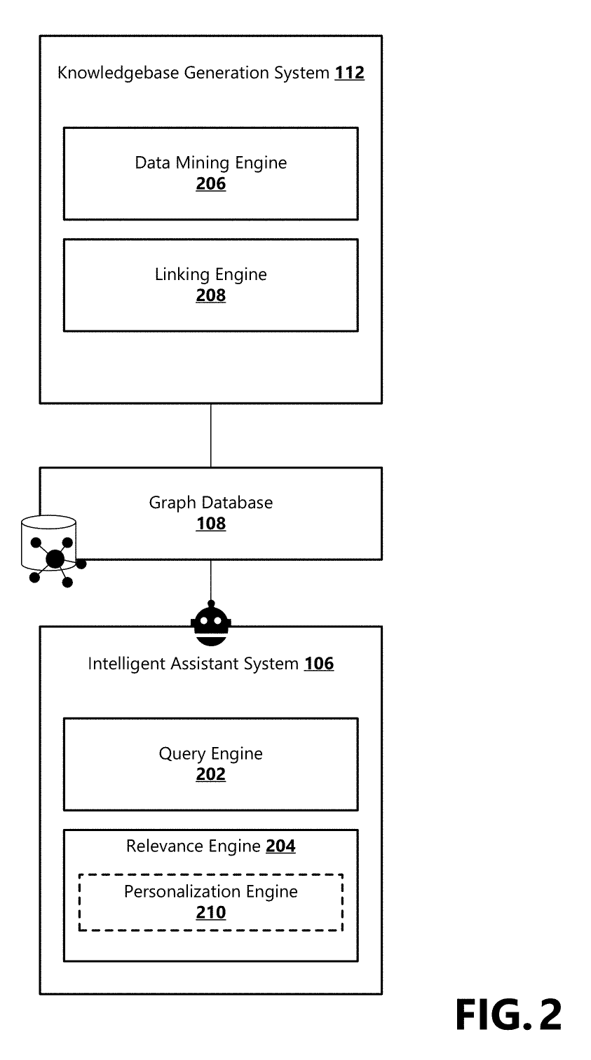

With reference now to FIG. 2, a block diagram illustrating various components of the intelligent assistant 106 and the knowledgebase generation system 112 is provided. According to an aspect, the knowledgebase generation system 112 includes a data mining engine 206 and a linking engine 208. The data mining engine 206 is illustrative of a software module, system, or device operative to mine various social networking data sources 116 for social data 114, and to perform machine learning techniques on the social data for detecting entities. In one example, natural language processing is used to extract a list of strings denoting key talking points in the social data 114 being analyzed. In another example, keywords, topics, categories, and entities can be extracted. In another example, topics for a collection of data are detected, wherein a topic may be identified with a key phrase, which can be one or more related words.

According to an aspect, the linking engine 208 is illustrative of a software module, system, or device operative to identify relationships between entities, and to calculate a score for identified relationships. In some examples, the score is associated with a calculated degree of relatedness between two entities based on social activity on the two entities. That is, a relationship between entities is stronger, and thus a relatedness score between the entities is higher when social data 114 mentioning the two entities or otherwise connecting the two entities is shared amongst many social media users or liked by users. The linking engine 208 is further operative to store the detected entities and computed relationships and scores in the graph knowledgebase 108, and to annotate the relationships by time for temporal versioning of the graph. According to an aspect, the data mining engine 206 and the linking engine 208 are language agnostic. That is, the mining engine 206 and the linking engine 208 are operative to learn connections by normalizing social data 114 that is published in other languages to a common language, such that entities in the social data can be discovered.

In one example, a high or strong relatedness score between entity “X” and entity “Y” can be based on one or a combination of: a number of posts or social data items 114 that mention “X” and “Y,” a number of re-posts of a post that mentions “X” and “Y,” a number of likes of a post that mentions “X” and “Y,” based on a person posting about “X” and “Y,” and the person's relationship between “X” or “Y,” or based on a time-decay factor (e.g., based on a post's age, measured backward from the current time). As an example, consider that entity “P” is a first social data item 114 (e.g., social media post) that includes entity “X,” where “X” is the movie Star Wars, and entity “Y,” where “Y” is the late-actress Carrie Fisher, who starred in Star Wars. Also consider that another Star Wars actor (e.g., Harrison Ford—entity “Z”) is the author of the social media post “P.” Accordingly, the linking engine 208 is operative to identify, compute, and store a relationship between the social media post (entity “P”) and Star Wars (entity “X”), a relationship between the social media post (entity “P”) and Carrie Fisher (entity “Y”), a relationship between Star Wars (entity “X”) and Carrie Fisher (entity “Y”), and a relationship between Harrison Ford (entity “Z”) and the social media post (entity “P”). Further, a relationship between Harrison Ford (entity “Z”) and Star Wars (entity “X”) and a relationship between Harrison Ford (entity “Z”) and Carrie Fisher (entity “Y”) can be identified, computed, and stored in the graph knowledgebase 108. If the social media post is re-posted or liked many times by other social media users, the strength(s) of the relationship(s) are increased. Additionally or alternatively, recency of the post or posts can positively influence a relatedness score, while a relationship between entities based on older social data 114 can have a lower relatedness score.

According to an aspect, the intelligent assistant 106 includes a query engine 202 and a relevance engine 204. The query engine 202 is illustrative of a software module, system, or device operative to receive a query from the user 102, to understand the query or the user's intent, and to query the graph knowledgebase 108 for social data 114 responsive to the query. In some examples, the query engine 202 understands entities mentioned by the user 102, such as social networking posts, authors of social networking site posts, and people, places, organizations, movie titles, book titles, current events, sports teams, or other topics of interest that are mentioned in social networking posts. In some examples, the query engine 202 includes a linguistic service, operative to receive a natural language query and classify the query into an intent. Based on one or more entities identified in the user's query, the query engine 202 is further operative to query the graph knowledgebase 108 for information related to the query. In one example, a portion of the graph knowledgebase 108 is extracted, and the query engine 202 traverses the graph for discovering other entities, relationships, and associated relatedness scores. Responsive to the graph knowledgebase 108 query, one or more information items are returned to the query engine 202. In examples, the information items include information extracted from currently trending social data 114 (e.g., a social media post, article, or page), such as an excerpt, a description, an abstract, a link, a hashtag, etc. In some examples, when information related to a query is not discovered in the graph knowledgebase 108, the query engine 202 is operative to query other data sources 124 for responsive information to provide to the user 102. For example, the query engine 202 is operative to query a web data source 124, such as a news site, for interesting or relevant content.

According to an aspect, the relevance engine 204 is illustrative of a software module, system, or device operative to select information to provide to the user 102 in response to the user's query. For example, the query on the graph knowledgebase 108 is likely to surface a plurality of information items ranked by relatedness scores. In some examples, the relevance engine 204 is operative to provide a highest ranking information item to the user 102. In other examples, the relevance engine 204 includes a personalization engine 210 operative to filter information items according to relevance based on a user profile. In some examples, the relatedness score can be incremented or decremented based on personalization information, such as the user's job title, known interests, location, time of day, etc. In one example, the user profile is pre-set by the user 102. In another example, the user profile is automatically inferred based on other information sources or user interaction data. For example, a particular social data 114 item may be selected for a user based on the user's job title, known interests, location, time of day, etc.

According to an aspect, the information item is returned to the user 102 as a result or response via the communication channel via which the query was received (e.g., displayed in textual form in a UI 122, spoken in an audible response). The user 102 is further enabled to provide a follow-up query. In some examples, the follow-up query is related to the received information item, such as “tell me something else about “X.” Accordingly, the relevance engine 204 is operative to select another highest ranking information item from the information items returned to the query engine 202 to provide to the user 102.

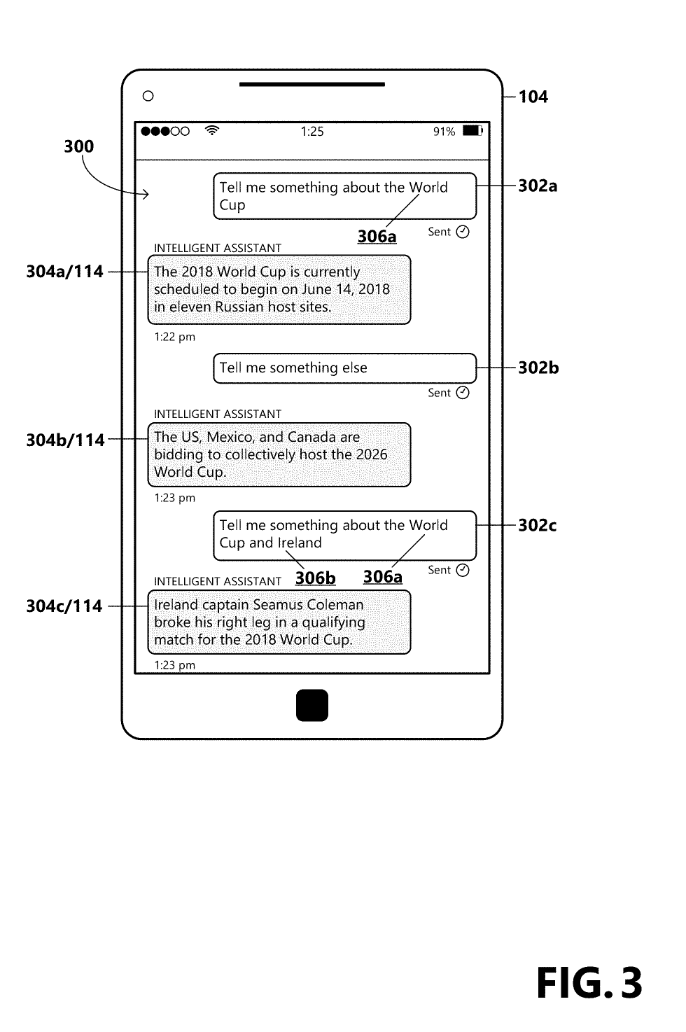

With reference now to FIG. 3, an example conversation 300 between the intelligent assistant 106 and a user 102 is illustrated. The example conversation 300 is embodied as a series of text messages sent via a text messaging system (communication channel). As should be appreciated, various communication channels may be utilized, and various user interface technologies may be employed where user input may be received via hardware input devices, such as mice, keyboards, remote controls, pens/styluses, and the like. As another example, user input may be received via natural input devices/methods that enable a user to interact with the computing device in a “natural” manner, such as those relying on speech recognition, touch and stylus recognition, gesture recognition both on screen and adjacent to the screen, air gestures, head and eye tracking, voice and speech, vision, touch, hover, gestures, and machine intelligence. Responses can be made visible to the user in the form of text, images, or other visual content shown on a display within a graphical user interface (GUI). A response may also comprise computer-generated speech or other audio content that is played back via speaker(s) of the computing device or connected to the computing device.

In the illustrated example, the user 102 provides a first query 302a, which the intelligent assistant 106 receives and analyzes. A determination is made that the user's intent is a request for information about the World Cup (i.e., first entity 306a) based on natural language processing or recognition of keywords or related keywords. A query is made on the graph knowledgebase 108 for trending social data 114 related to the World Cup (i.e., first entity 306a), and a first information item 304a having a highest relatedness score to the first entity 306a is provided to the user 102 in a first response. According to an aspect, the first information item 304a includes information parsed from social data 114 that is currently trending based on shares, likes, re-posts, mentions, etc. In some examples, an information item 304 includes all the content from a social data item 114. In other examples, an information item 304 includes a portion of a social data item 114. In other examples, an information item 304 includes a link to a social data item 114.

In a subsequent query 302b, the user 102 provides follow-up query input that is received by the intelligent assistant 106 and analyzed. In response to determining that the user's intent is to receive additional information about the first entity 306a (i.e., World Cup), the intelligent assistant 106 selects a second information item 304b having a next-highest relatedness score to the first entity, and provides the second information item 304b to the user 102 in a second response. According to an aspect, the second information item 304b includes information parsed from social data 114 that is currently trending based on shares, likes, re-posts, mentions, etc.

In a next query 302c, the user 102 provides follow-up query input that is received by the intelligent assistant 106 and analyzed. In response to determining that the user's intent is to receive information related to the first entity 306a (i.e., World Cup) and to a second entity 306b (i.e., Ireland), the intelligent assistant 106 selects a highest-ranking information item 304c responsive to “World Cup” and “Ireland,” and provides the information item 304c to the user 102 in a third response. According to an aspect, the third information item 304c includes information parsed from social data 114 that is currently trending based on shares, likes, re-posts, mentions, etc.

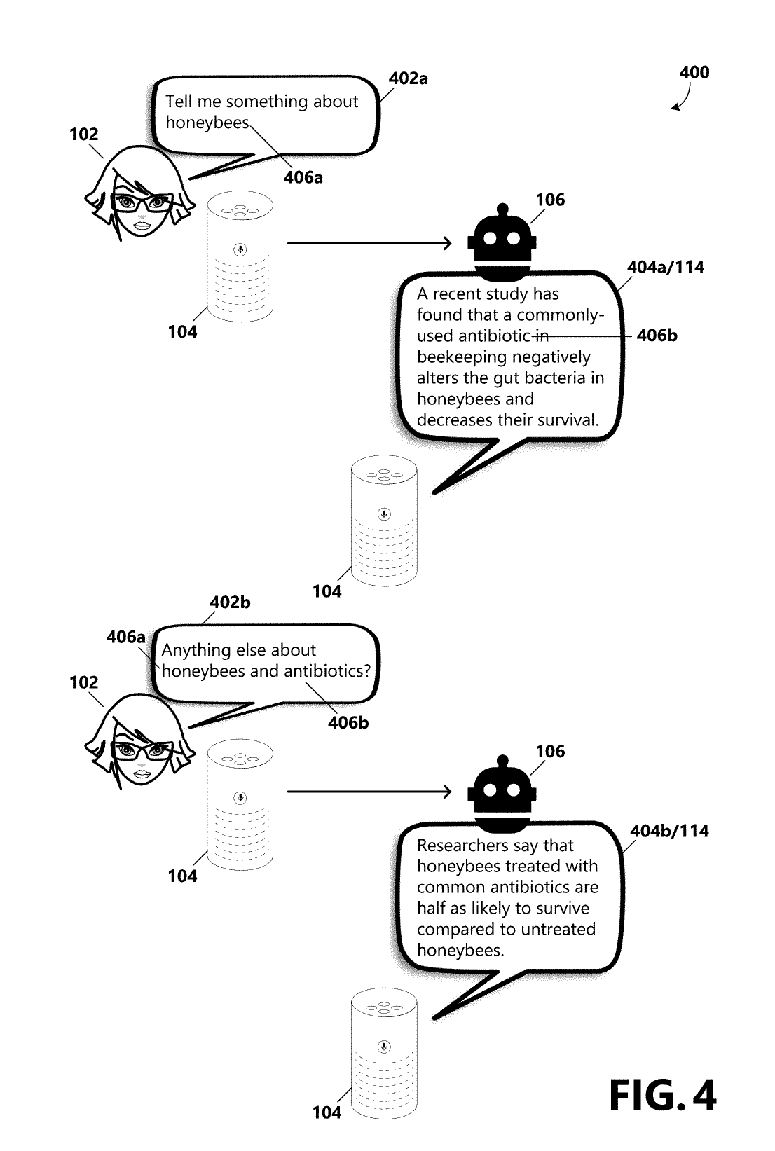

With reference now to FIG. 4, another example conversation 400 between a user 102 and the intelligent assistant 106 is illustrated. The example conversation 400 is embodied as a series of spoken messages communicated via a smart home speaker system (communication channel). In the illustrated example, the user 102 provides a first query 402a, which the intelligent assistant 106 receives and analyzes. A determination is made that the user's intent is a request for information about honeybees (i.e., first entity 406a) based on natural language processing or recognition of keywords or related keywords. A query is made on the graph knowledgebase 108 for trending social data 114 related to the first entity 406a (i.e., honeybees), and a first information item 404a is selected from related social data. In one example, the first information item 404a is selected based on a highest relatedness score between the first information item and the first entity 406a. In another example, the first information item 404a is selected based on personalized relevance to the user 102. For example, the relatedness score can be incremented or decremented based on the user's job title, known interests, location, time of day, etc. In some examples, personalization information is obtained from a user profile associated with the user 102, such as a user profile pre-set by the user 102 or automatically inferred based on other information sources or user interaction data.

The first information item 404a is provided to the user 102 in a first response. In the illustrated example, the first information item 404a is a fragment of a social media post (i.e., social data item 114) that includes information about honeybees (i.e., first entity 406a) and antibiotics (i.e., second entity 406b). According to an example, the first information item 404a may be selected based on personalization information that the user 102 is interested in information about the use of antibiotics, which may have been explicitly defined in a user profile or implicitly defined based on social data that the user regularly reads or posts. According to an aspect, the first information item 404a includes information parsed from social data 114 that is currently trending based on shares, likes, re-posts, mentions, etc.

In a subsequent query 402b, the user 102 provides follow-up query input that is received by the intelligent assistant 106 and analyzed. In response to determining that the user's intent is to receive information related to the first entity 406a (i.e., honeybees) and to the second entity 406b (i.e., antibiotics), the intelligent assistant 106 selects a highest-ranking information item 404b related to “honeybees” and “antibiotics,” and provides the information item 404b to the user 102 in a second response. According to an aspect, the second information item 404b includes information parsed from social data 114 that is currently trending based on shares, likes, re-posts, mentions, etc.

Having described an operating environment 100, components of the temporally relevant social data search system 110, and various use case examples with respect to FIGS. 1-4, FIG. 5 is a flow chart showing general stages involved in an example method 500 for generating a knowledge database 110 for providing temporally relevant social data 114.

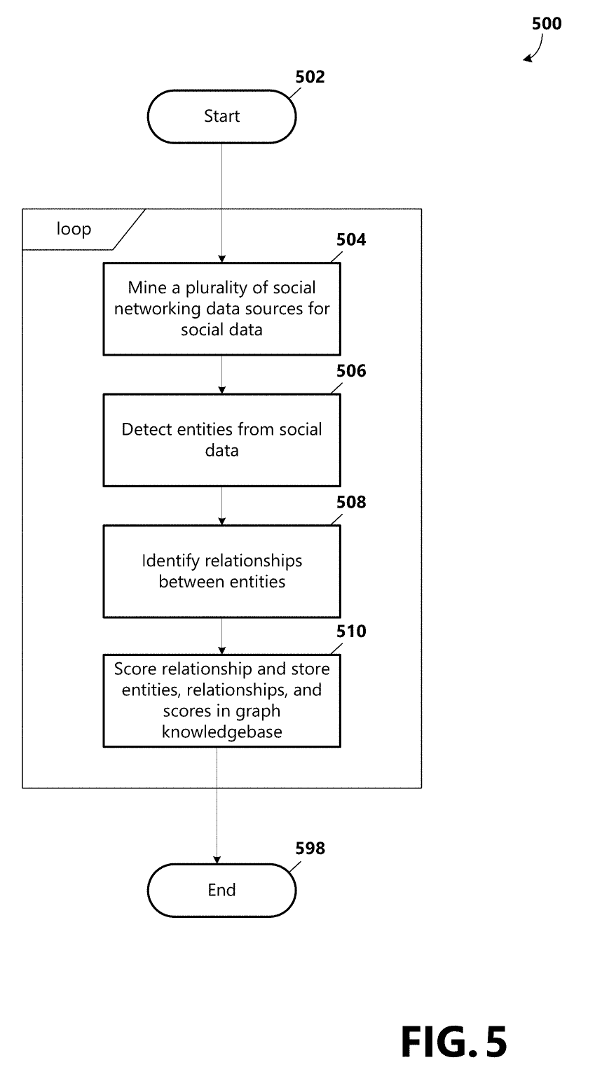

With reference now to FIG. 5, the method 500 begins at START OPERATION 502, and proceeds to OPERATION 504, where the data mining engine 206 mines a plurality of social networking data sources 116 for social data 114, such as posts, articles, links, hashtags, photos, images, videos, and the like.

The method 500 proceeds to OPERATION 506, where the social data 114 is parsed for identifying entities 306,406. In some examples, the data mining engine 206 utilizes machine learning techniques for identifying entities 306,406. For example, the data mining engine 206 analyzes social data 114, and extracts entities 306,406, such as social networking posts, authors of social networking site posts, and people, places, organizations, movie titles, book titles, current events, sports teams, or other topics of interest that are mentioned in social networking posts, etc.

At OPERATION 508, relationships between entities 306,406 are detected. In one example, detection of a relationship between entities 306,406 is based on a mention of entity “X” and entity “Y” in a social data item. In another example, detection of a relationship between entities 306,406 is based on a person posting about “X” and/or “Y.” In another example, detection of a relationship between entities 306,406 is based on a person's relationship between “X” or “Y.”

At OPERATION 510, degree of relatedness between entities 306,406 is calculated. For example, a relatedness score between entities is calculated based on an amount and recency of social activity (e.g., shares, likes, posts, re-posts) associated with the two entities. Further, the entities 306,406, relationships between entities, and relatedness score data are stored in the graph knowledgebase 108. According to an example, the relationships are annotated by time for temporal versioning of the graph. According to an aspect, mining of social networking data sources 116 for social data 114 and updating the graph knowledgebase 108 is a continual process. The method 500 ends at OPERATION 598.

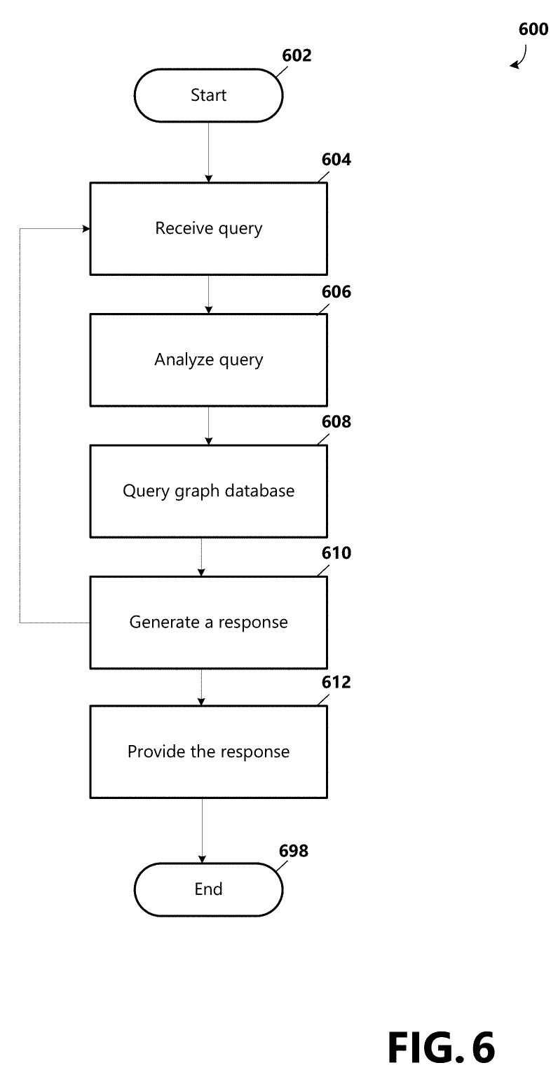

FIG. 6 is a flow chart showing general stages involved in an example method 600 for providing temporally relevant social data 114. With reference now to FIG. 6, the method 600 begins at START OPERATION 602, and proceeds to OPERATION 604, where a query 302,402 is received. For example, the user 102 communicates with the intelligent assistant 106 via textual input, spoken input, etc. According to an aspect, the query 302,402 is an exploratory query for information related to one or more entities 306,406.

The method 600 proceeds to OPERATION 606, where the received query 302,402 is analyzed. For example, the intelligent assistant 106 understands entities 306,406 mentioned in the query, such as social networking posts, authors of social networking site posts, and people, places, organizations, movie titles, book titles, current events, sports teams, or other topics of interest that are mentioned in social networking posts, etc.

The method 600 proceeds to OPERATION 608, where the intelligent assistant 106 queries the knowledge database 110 for information related to the one or more entities 306,406 identified in the query. In one example, a portion of a most-current snapshot of the graph knowledgebase 108 is extracted, and the query engine 202 traverses the graph for discovering other entities, relationships, and associated relatedness scores.

At OPERATION 610, responsive to the graph knowledgebase 108 query, one or more information items 304,404 that include information extracted from currently-trending social data 114 (e.g., a social media post, article, or page) are returned to the intelligent assistant 106. Further at OPERATION 610, an information item 304,404 is selected for inclusion in a response to the query 302,402. For example, an information item 304,404 having a highest relatedness score is selected for the response. In some examples, the relatedness score is incremented or decremented according to relevance based on a user profile that can be pre-set by the user 102 or automatically inferred based on other information sources or user interaction data.

At OPERATION 610, the response is provided to the user 102 via the communication channel 612 that the query was received at OPERATION 604. For example, the response includes an information item comprising information extracted from currently trending social data 114 (e.g., a social media post, article, or page), such as an excerpt, a description, an abstract, a link, a hashtag, etc. The method may return to OPERATION 604, where a follow-up query from the user 102 is received, or else, the method 600 ends at OPERATION 698.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 7-9 and the associated descriptions provide a discussion of a variety of operating environments in which examples are practiced. However, the devices and systems illustrated and discussed with respect to FIGS. 7-9 are for purposes of example and illustration and are not limiting of a vast number of computing device configurations that are utilized for practicing aspects, described herein.

FIG. 7 is a block diagram illustrating physical components (i.e., hardware) of a computing device 700 with which examples of the present disclosure are be practiced. In a basic configuration, the computing device 700 includes at least one processing unit 702 and a system memory 704. According to an aspect, depending on the configuration and type of computing device, the system memory 704 comprises, but is not limited to, volatile storage (e.g., random access memory), non-volatile storage (e.g., read-only memory), flash memory, or any combination of such memories. According to an aspect, the system memory 704 includes an operating system 705 and one or more program modules 706 suitable for running software applications 750. According to an aspect, the system memory 704 includes the temporally relevant social data search system 110. The operating system 705, for example, is suitable for controlling the operation of the computing device 700. Furthermore, aspects are practiced in conjunction with a graphics library, other operating systems, or any other application program, and is not limited to any particular application or system. This basic configuration is illustrated in FIG. 7 by those components within a dashed line 708. According to an aspect, the computing device 700 has additional features or functionality. For example, according to an aspect, the computing device 700 includes additional data storage devices (removable and/or non-removable) such as, for example, magnetic disks, optical disks, or tape. Such additional storage is illustrated in FIG. 7 by a removable storage device 709 and a non-removable storage device 710.

As stated above, according to an aspect, a number of program modules and data files are stored in the system memory 704. While executing on the processing unit 702, the program modules 706 (e.g., temporally relevant social data search system 110) perform processes including, but not limited to, one or more of the stages of the method 500 illustrated in FIG. 5 and method 600 illustrated in FIG. 6. According to an aspect, other program modules are used in accordance with examples and include applications such as electronic mail and contacts applications, word processing applications, spreadsheet applications, database applications, slide presentation applications, drawing or computer-aided drafting application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 7 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 700 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 700 has one or more input device(s) 712 such as a keyboard, a mouse, a pen, a sound input device, a touch input device, etc. The output device(s) 714 such as a display, speakers, a printer, etc. are also included according to an aspect. The aforementioned devices are examples and others may be used. According to an aspect, the computing device 700 includes one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. According to an aspect, any such computer storage media is part of the computing device 700. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

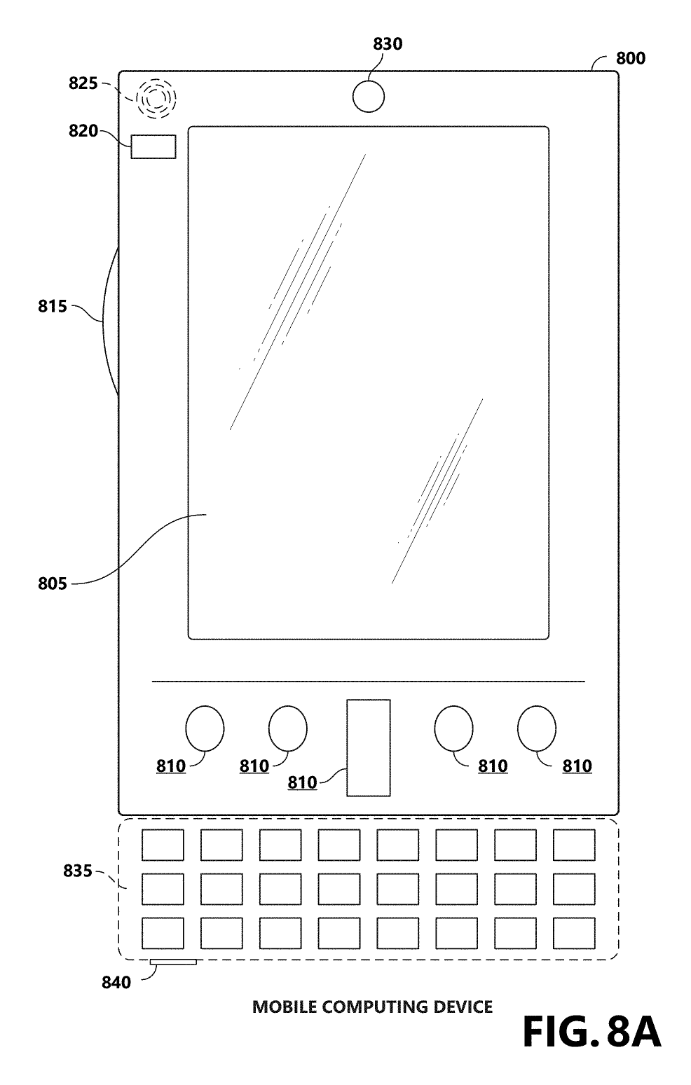

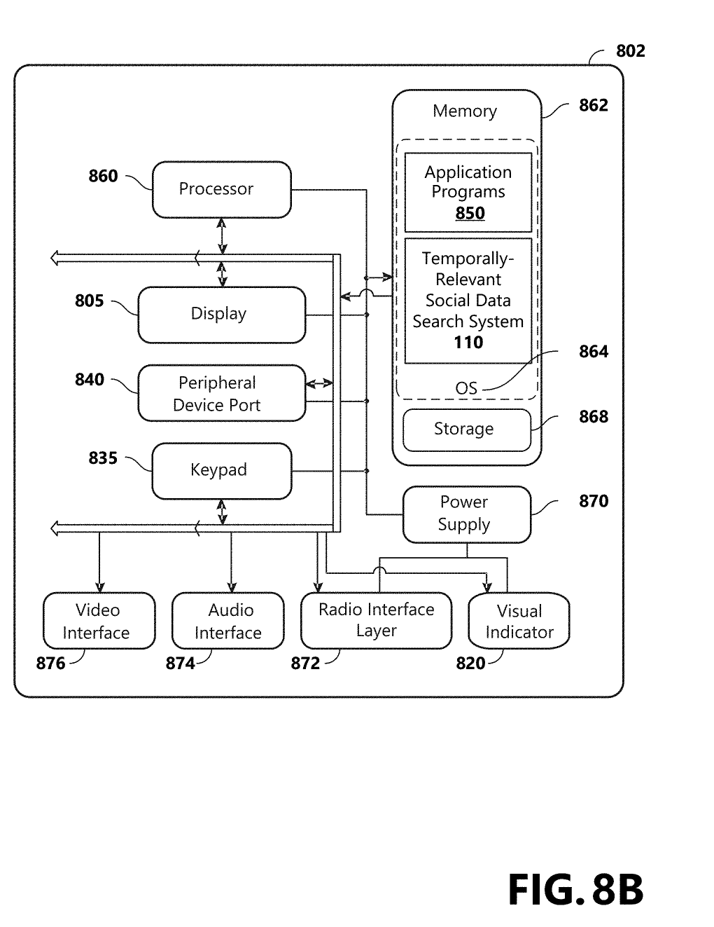

FIGS. 8A and 8B illustrate a mobile computing device 800, for example, a mobile telephone, a smart phone, a tablet personal computer, a laptop computer, and the like, with which aspects may be practiced. With reference to FIG. 8A, an example of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. According to an aspect, the display 805 of the mobile computing device 800 functions as an input device (e.g., a touch screen display). If included, an optional side input element 815 allows further user input. According to an aspect, the side input element 815 is a rotary switch, a button, or any other type of manual input element. In alternative examples, mobile computing device 800 incorporates more or less input elements. For example, the display 805 may not be a touch screen in some examples. In alternative examples, the mobile computing device 800 is a portable phone system, such as a cellular phone. According to an aspect, the mobile computing device 800 includes an optional keypad 835. According to an aspect, the optional keypad 835 is a physical keypad. According to another aspect, the optional keypad 835 is a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some examples, the mobile computing device 800 incorporates a vibration transducer for providing the user with tactile feedback. In yet another example, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 800 incorporates peripheral device port 840, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one example of a mobile computing device. That is, the mobile computing device 800 incorporates a system (i.e., an architecture) 802 to implement some examples. In one example, the system 802 is implemented as a “smart phone” capable of running one or more applications (e.g., browser, e-mail, calendaring, contact managers, messaging clients, games, and media clients/players). In some examples, the system 802 is integrated as a computing device, such as an integrated personal digital assistant (PDA) and wireless phone.

According to an aspect, one or more application programs 850 are loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. According to an aspect, the temporally relevant social data search system 110 is loaded into memory 862. The system 802 also includes a non-volatile storage area 868 within the memory 862. The non-volatile storage area 868 is used to store persistent information that should not be lost if the system 802 is powered down. The application programs 850 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

According to an aspect, the system 802 has a power supply 870, which is implemented as one or more batteries. According to an aspect, the power supply 870 further includes an external power source, such as an AC adapter or a powered docking cradle that supplements or recharges the batteries.

According to an aspect, the system 802 includes a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 850 via the operating system 864, and vice versa.

According to an aspect, the visual indicator 820 is used to provide visual notifications and/or an audio interface 874 is used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. According to an aspect, the system 802 further includes a video interface 876 that enables an operation of an on-board camera 830 to record still images, video stream, and the like.

According to an aspect, a mobile computing device 800 implementing the system 802 has additional features or functionality. For example, the mobile computing device 800 includes additional data storage devices (removable and/or non-removable) such as, magnetic disks, optical disks, or tape. Such additional storage is illustrated in FIG. 8B by the non-volatile storage area 868.

According to an aspect, data/information generated or captured by the mobile computing device 800 and stored via the system 802 is stored locally on the mobile computing device 800, as described above. According to another aspect, the data is stored on any number of storage media that is accessible by the device via the radio 872 or via a wired connection between the mobile computing device 800 and a separate computing device associated with the mobile computing device 800, for example, a server computer in a distributed computing network, such as the Internet. As should be appreciated such data/information is accessible via the mobile computing device 800 via the radio 872 or via a distributed computing network. Similarly, according to an aspect, such data/information is readily transferred between computing devices for storage and use according to well-known data/information transfer and storage means, including electronic mail and collaborative data/information sharing systems.

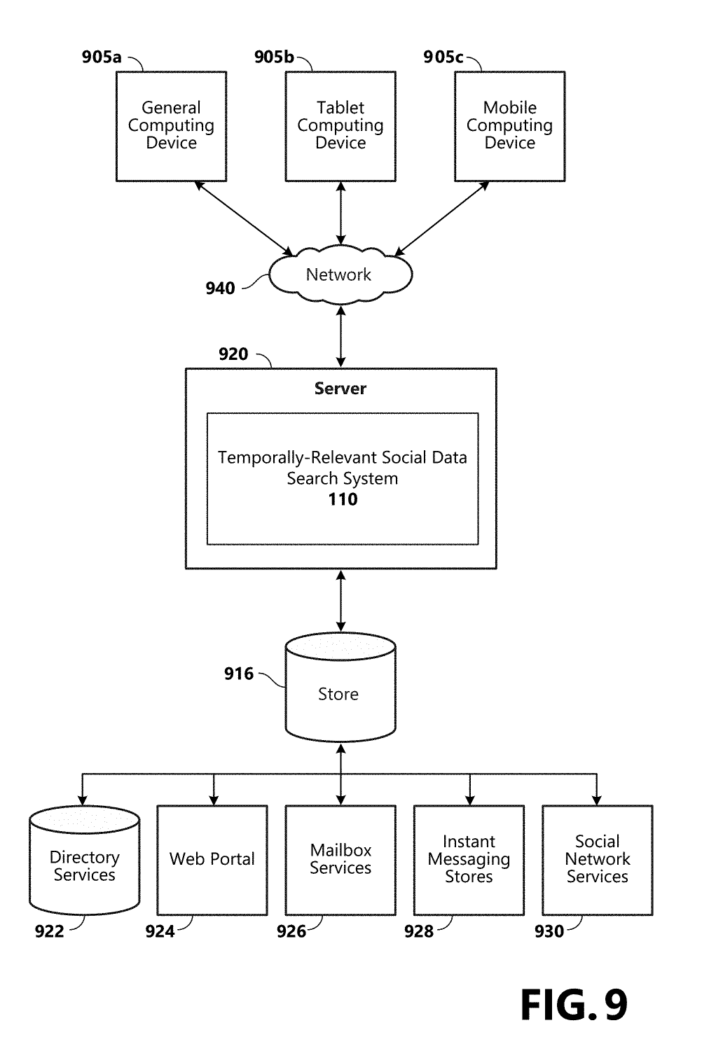

FIG. 9 illustrates one example of the architecture of a system for surfacing temporally relevant social data 114 responsive to an exploratory query, as described above. Content developed, interacted with, or edited in association with the temporally relevant social data search system 110 is enabled to be stored in different communication channels or other storage types. For example, various documents may be stored using a directory service 922, a web portal 924, a mailbox service 926, an instant messaging store 928, or a social networking site 930. The temporally relevant social data search system 110 is operative to use any of these types of systems or the like for surfacing temporally relevant social data 114 responsive to an exploratory query, as described herein. According to an aspect, a server 920 provides the temporally relevant social data search system 110 to clients 905a,b,c. As one example, the server 920 is a web server providing the temporally relevant social data search system 110 over the web. The server 920 provides the temporally relevant social data search system 110 over the web to clients 905 through a network 940. By way of example, the client computing device is implemented and embodied in a personal computer 905a, a tablet computing device 905b or a mobile computing device 905c (e.g., a smart phone), or other computing device. Any of these examples of the client computing device are operable to obtain content from the store 916.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for providing a relevant informational item to a user, comprising:
mining a plurality of social networking data sources for collecting social data items;
parsing the collected social data items for detecting entities;
generating a graph knowledgebase storing a first node representing a first entity, wherein the first entity is a social data item from the collected social data items, a second node representing a second entity, wherein the second entity is associated with the social data item, and an edge representing a relationship connecting the first node and the second node;
responsive to receiving an exploratory query by the user for information associated with the second entity, querying the graph knowledgebase for identifying social data items related to the second entity;
selecting a social data item related to the second entity based on a relatedness score, the relatedness score based at least in part on an amount of and recency of social activity associated with the first entity and the second entity;
generating a response to the user including the information parsed from the selected social data item; and
delivering the response to the user via a communication channel.

2. The method of claim 1, wherein selecting the social data item further comprises:
determining whether the social data item includes information relevant to the user based on personalization information;
when the social data item includes information relevant to the user based on personalization information, incrementing the relatedness score; and
when the social data item does not include information relevant to the user based on personalization information, decrementing the relatedness score.

3. The method of claim 2, wherein determining whether the social data item includes information relevant to the user comprises determining whether the social data item includes information relevant to the user based on personalization information explicitly defined by the user in a user profile.

4. The method of claim 2, wherein determining whether the social data item includes information relevant to the user comprises determining whether the social data item includes information relevant to the user based on personalization information implicitly defined based on user interaction data.

5. The method of claim 1, wherein generating the graph knowledgebase comprises storing the second node representing the second entity, wherein the second entity is an entity mentioned in the social data item represented by the first node.

6. The method of claim 1, wherein generating the graph knowledgebase comprises storing the second node representing the second entity, wherein the second entity is an author of the social data item represented by the first node.

7. The method of claim 1, wherein calculating the relatedness score comprises calculating the relatedness score based on a number of:
shares;
likes,
posts, or
re-posts.

8. The method of claim 1, wherein querying the graph knowledgebase comprises:
extracting a portion of the graph knowledgebase including the second entity; and
traversing the extracted portion of the graph knowledgebase for discovering other entities, relationships, and associated relatedness scores.

9. The method of claim 1, further comprising:
continually mining the plurality of social networking data sources for collecting social data items;
parsing the collected social data items for detecting entities; and
updating the graph knowledgebase with the detected entities and relationships connecting the entities.

10. The method of claim 1, further comprising:
responsive to a follow-up exploratory query by the user for information associated with the second entity and a third entity, querying the graph knowledgebase for identifying other entities related to the second entity and the third entity;
selecting a social data item related to the second entity and the third entity based on a relatedness score;
generating a response to the user including the information parsed from the selected social data item; and
delivering the response to the user via a communication channel.

11. A system for providing a relevant informational item to a user, comprising:
a processing unit; and
a memory, including computer readable instructions, which when executed by the processing unit is operable to provide a temporally relevant social data search system operative to:
mine a plurality of social networking data sources for collecting social data items;
parse the collected social data items for detecting entities;
generate a graph knowledgebase storing a first node representing a first entity, wherein the first entity is a social data item from the collected social data items, a second node representing a second entity, wherein the second entity is associated with the social data item, and an edge representing a relationship connecting the first node and the second node;
calculate a relatedness score between the first entity and the second entity based at least in part on an amount of and recency of social activity associated with the first entity and the second entity;
responsive to receiving an exploratory query by the user for information associated with the second entity, query the graph knowledgebase for identifying social data items related to the second entity;
increase the relatedness score of identified social data items related to the second entity that include information relevant to the user based on personalization information;
select a social data item related to the second entity based on the relatedness score;
generate a response to the user including the information parsed from the selected social data item; and
deliver the response to the user via a communication channel.

12. The system of claim 11, wherein:
the personalization information is explicitly defined by the user in a user profile; or
the personalization information is implicitly defined based on user interaction data.

13. The system of claim 11, wherein in calculating the relatedness score, the temporally relevant social data search system is operative to calculate the relatedness score based on a number of:
shares;
likes,
posts, or
re-posts.

14. The system of claim 11, wherein in querying the graph knowledgebase, the temporally relevant social data search system is operative to:
extract a portion of the graph knowledgebase including the second entity; and
traverse the extracted portion of the graph knowledgebase for discovering other entities, relationships, and associated relatedness scores.

15. The system of claim 11, wherein the temporally relevant social data search system is further operative to
continually mine the plurality of social networking data sources for collecting social data items;
parse the collected social data items for detecting entities; and
update the graph knowledgebase with the detected entities and relationships connecting the entities.

16. The system of claim 11, wherein the temporally relevant social data search system is further operative to:
responsive to a follow-up exploratory query by the user for information associated with the second entity and a third entity, query the graph knowledgebase for identifying other entities related to the second entity and the third entity;
select a social data item related to the second entity and the third entity based on a relatedness score;
generate a response to the user including the information parsed from the selected social data item; and
deliver the response to the user via a communication channel.

17. A computer readable storage device including computer readable instructions, which when executed by a processing unit is operable to:
mine a plurality of social networking data sources for collecting social data items;
parse the collected social data items for detecting entities;
generate a graph knowledgebase storing a first node representing a first entity, wherein the first entity is a social data item from the collected social data items, a second node representing a second entity, wherein the second entity is associated with the social data item, and an edge representing a relationship connecting the first node and the second node;
calculate a relatedness score between the first entity and the second entity based at least in part on an amount of and recency of social activity associated with the first entity and the second entity;
responsive to receiving an exploratory query by the user for information associated with the second entity, query the graph knowledgebase for identifying social data items related to the second entity;
increase a relatedness score of identified social data items related to the second entity that include information relevant to the user based on personalization information;
select a social data item related to the second entity based on the relatedness score;
generate a response to the user including the information parsed from the selected social data item; and
deliver the response to the user via a communication channel.

18. The computer readable storage device of claim 17, wherein:
the personalization information is explicitly defined by the user in a user profile; or
the personalization information is implicitly defined based on user interaction data.

19. The computer readable storage device of claim 17, wherein the device is further operative to:
continually mine the plurality of social networking data sources for collecting social data items;
parse the collected social data items for detecting entities; and
update the graph knowledgebase with the detected entities and relationships connecting the entities.

20. The computer readable storage device of claim 17, wherein in querying the graph knowledgebase, the device is operative to:
extract a portion of the graph knowledgebase including the second entity; and
traverse the extracted portion of the graph knowledgebase for discovering other entities, relationships, and associated relatedness scores.
